(19) United States
(12) Patent Application Publication
(10) Pub. No.: US 2014/0007213 A1
(43) Pub. Date: Jan. 2, 2014

(54) SYSTEMS AND METHODS FOR PUSH NOTIFICATION BASED APPLICATION AUTHENTICATION AND AUTHORIZATION

(71) Applicant: WePay, Inc., Palo Alto, CA (US)

(72) Inventors: Aleksey Sanin, Sunnyvale, CA (US); Matt Ricketson, Westford, MA (US); Ryan Newlman, San Francisco, CA (US); Andrew LeBlanc, Menlo Park, CA (US); Eric Stern, East Palo Alto, CA (US)

(21) Appl. No.: 13/915,475

(22) Filed: Jun. 11, 2013

Related U.S. Application Data
(60) Provisional application No. 61/666,155, filed on Jun. 29, 2012.

(51) Int. Cl. H04L 29/06

(52) U.S. Cl. CPC H04L 63/08
USPC 726/9

(57) ABSTRACT

A new approach is proposed that contemplates systems and methods to support authentication and authorization of an application running on a computing device or a mobile device to a web-based service provided by a remote server using a third-party push notification service available to the computing and/or mobile device. The application is only allowed to access and interact with the remote service after the application has been authenticated and authorized by the service provider. Unlike previous approaches, the proposed approach does not rely on any application-specific secrets associated with the application and stored on the computing or mobile device. Instead it utilizes the generic third-party push notification service security mechanisms that are available to the computing and/or mobile device.

### CROSS-REFERENCE TO RELATED APPLICATIONS

This application claims the benefit of U.S. Provisional Patent Application No. 61/666,155, filed Jun. 29, 2012, and entitled “Push notification based application authentication and authorization,” and is hereby incorporated herein by reference.

### BACKGROUND

An application installed on a user's computing or mobile device inherently operates in a hostile environment. A hacker may gain complete control over the device; have access to the application execution code and any data the application stores on the computing or mobile device. Thus, if the application performs any privileged actions on a remote service then the application cannot use any kind of client-side “secrets” deployed with the application in order to authenticate itself to the remote service since any such “secret” will be available to the hacker as well and thus pointless. Currently, the only solution employed is to have dedicated hardware with “secrets” embedded into the hardware of the computer or computing device. This hardware solution has numerous limitations and even then a dedicated hacker with unlimited resources can “break” into the hardware and get access to the “secret.”

Recent years have seen the increasing popularity of mobile devices, such as Apple's iOS-based devices and Google's Android-based devices, and the exponential growth of the number of applications or apps available to be downloaded and run on such mobile devices. For the apps running on the mobile devices, the hardware solution described above is no longer a feasible option for authentication and authorization of the apps since the hardware of the mobile devices are typically non-configurable. And even when the dedicated secure hardware is available, the device manufactures place restrictions on the usage of the hardware. A new approach is needed to ensure the authenticity of the apps and the security of the remote service and it associated data accessed by the apps running from the mobile devices.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system diagram to support push notification based application authentication and authorization.

FIG. 2 depicts an example of a process to support push notification based application authentication and authorization among a mobile device, a web service provider, and a third-party push notification service provider.

FIG. 3 depicts a flowchart of an example of a process to support push notification based application authentication and authorization.

### DETAILED DESCRIPTION OF THE EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to support authentication and authorization of an application running on a computing device or a mobile device to a web-based service provided by a remote server using a third-party push notification service available to the computing and/or mobile device. The application is only allowed to access and interact with the remote service after the application has been authenticated and authorized by the service provider. Unlike previous approaches, the proposed approach does not rely on any application-specific secrets associated with the application and stored on the computing or mobile device. Instead it utilizes the generic third-party push notification service security mechanisms that are available to the computing and/or mobile device. Any third-party push notification service with the appropriate security mechanisms can be utilized for the authentication and authorization of the application. For a non-limiting example, Apple's Push Notification (APN) system can be utilized for authentication and authorization of apps running on Apple's iOS-based devices.

The goal of the proposed application authentication and authorization approach is to ensure that a malicious application cannot impersonate the “good” application and perform privileged operations on a remote server providing the web service. The security of the proposed approach is based on the security of the communication channel between the remote server/service provider and the computing/mobile device running the application via the third-party push notification service available to the device. Here, the third-party push notification service must meet certain key security requirements in order to guarantee the safely delivery of a message/notification to its intended recipient (e.g., the application) so that the proposed approach can be successfully employed on top of any existing or future push notification service.

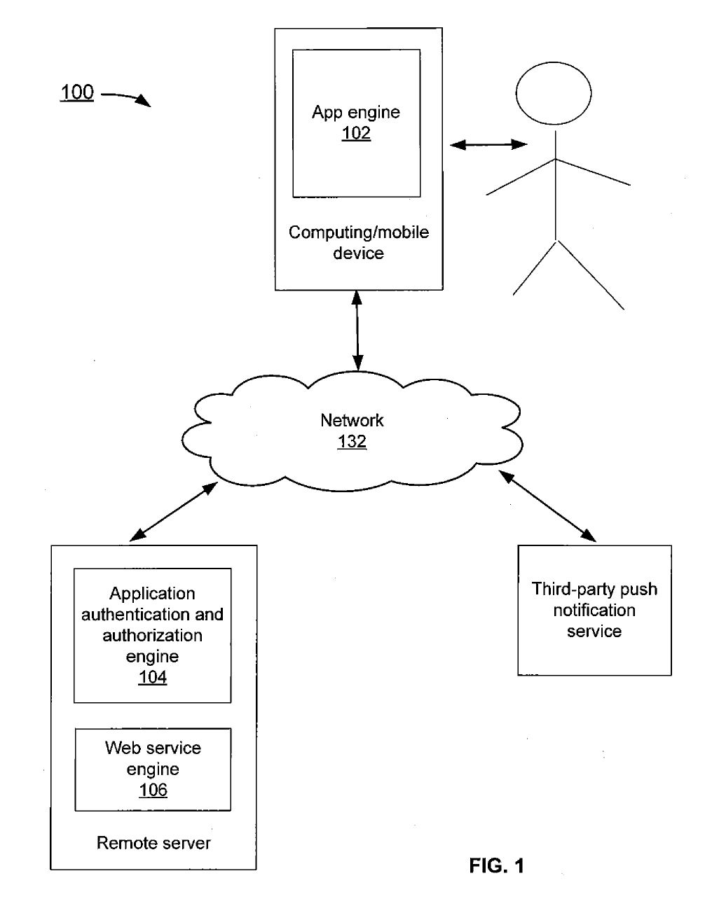

FIG. 1 shows an example of a system diagram to support push notification based application authentication and authorization. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes an app engine 102 running on a computing and/or mobile device, an application authentication and authorization engine 104 and an associated web service engine 106, both running on a remote server. As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

In the example of FIG. 1, each of the engines can run on one or more hosting devices (hosts). Here, a host can be a computing device, a communication device, a storage device, or any electronic device capable of running a software component. For non-limiting examples, a computing device can be but is not limited to a laptop PC, a desktop PC, a tablet PC, an iPod, an iPhone, a PDA, or a server machine. A storage device can be but is not limited to a hard disk drive, a flash memory drive, or any portable storage device. A communication device can be but is not limited to a mobile phone.

In the example of FIG. 1, each of the engines has a communication interface (not shown), which is a software component that enables the engines to communicate with each other following certain communication protocols, such as TCP/IP protocol. The communication protocols between two devices are well known to those of skill in the art.

In the example of FIG. 1, the network 132 enables the engines to communicate and interact with each other. Here, the network can be a communication network based on certain communication protocols, such as TCP/IP protocol. Such network can be but is not limited to, interne, intranet, wide area network (WAN), local area network (LAN), wireless network, Bluetooth, WiFi, mobile communication network, or any other network type. The physical connections of the network and the communication protocols are well known to those of skill in the art.

In the example of FIG. 1, app engine 102 is configured to enable a user to access, launch, and interact with an application or app stored on a computing and/or mobile device. App engine 102 is able to accept input from the user in the form of plain text commands and/or hand/finger gestures on a touchscreen associated with the computing and/or mobile device, wherein such hand/finger gestures are further interpreted by app engine 102 into commands and/or instructions executable on the computing and/or mobile device. App engine 102 is further configured to present status and/or the execution results of the commands and/or instructions to the user and may optionally request further input from the user.

In some embodiments, app engine 102 enables the user to register an app intended to access a web service provided by web service engine 106 running on a remote server for push notifications provided by a third-party push notification service. Such push notification service can be provided by any qualified third-party provider, such as Apple, Google, Sprint, AT & T, etc., which provides the underlying platform (such as iOS and Android) for the computing and/or mobile device and/or the mobile or wireless infrastructure for the communication channel. The key security requirements that are core for any third-party push notification service in order to guarantee the safely delivery of a message/notification to its intended recipient (application) include but are not limited to:
The push notification service must always deliver a notification sent by the remote service provider only to the application designated to access the service. This can be achieved by identifying the remote service and the application as client of the push notification service through the use of Public-Key Infrastructure (PKI) or by other means specific to the implementation of the push notification service.
The notification sent by the remote service provider must always be delivered to the computing and/or mobile device to which the device token was generated for.
The notification message is protected (encrypted) when being transmitted over the network among app engine 102, app authentication and authorization engine 104, and the third-party push notification service provider.

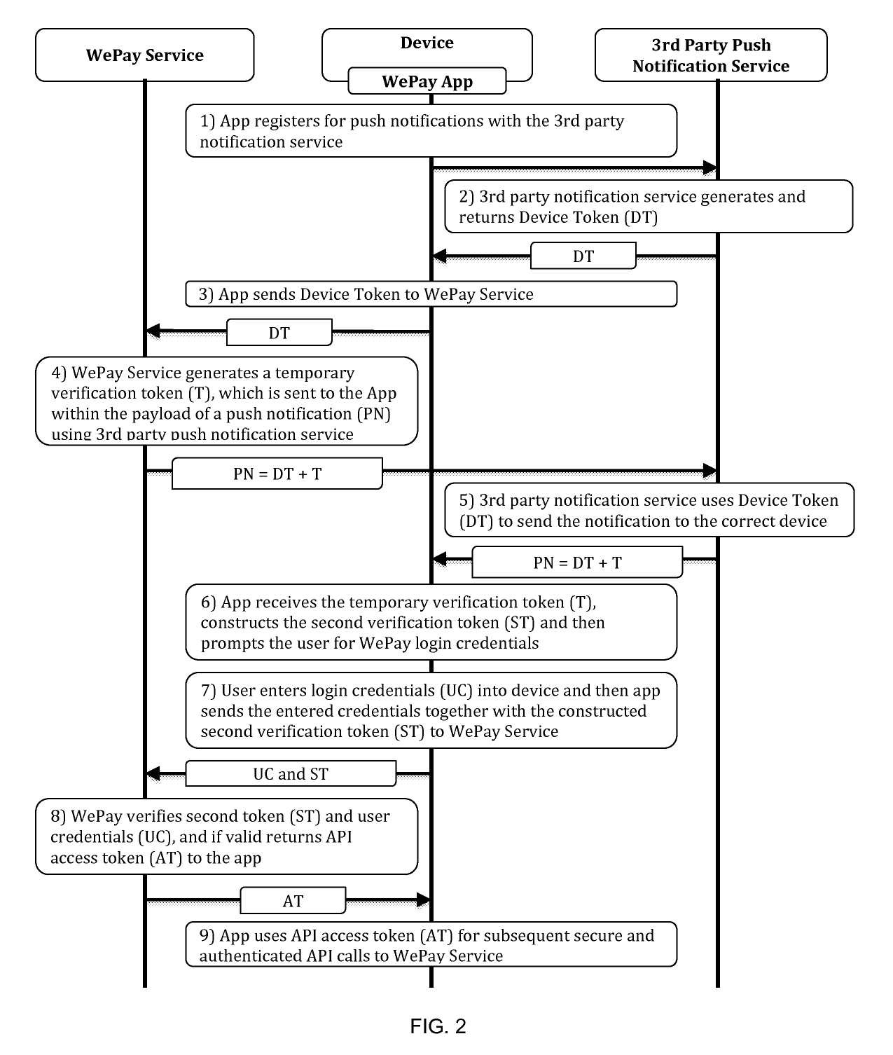

As depicted by the non-limiting example of the application authentication and authorization process of FIG. 2, app engine 102 enables the user to registrar the app for push notification service with the third-party provider (e.g., Apple) via an asynchronous process that requests a device token from Apple's push notification service (Step 1). Upon receiving the registration request from the app submitted via app engine 102, the push notification service generates and returns a device token (DT) directly to the application/app, wherein the device token is associated with the computing and/or mobile device on which the app is running and can be used by the push notification service to determine which computing/mobile device to send future push notifications to (Step 2).

Once the device token is received, app engine 102 running on the computing/mobile device forwards the token to application authentication and authorization engine 104 running on a remote server (Step 3), wherein application authentication and authorization engine 104 receives and stores the device token. Also running on the remote server is web service engine 106, which provides the remote service (e.g., WePay) and optionally associated data to be accessed by the app. The app running on the computing/mobile device goes into a waiting state after sending the device token until a push notification arrives later. During the waiting state, app engine 102 updates the user interface on the computing/mobile device to display “loading” state to the user.

In the example of FIGS. 1 and 2, application authentication and authorization engine 104 generates a temporary verification token (T), which is sent to the third-party push notification service within the payload of a push notification (PN) (Step 4). This verification token is for one-time-use only and has a time-limited lifespan, e.g., the verification token will expire after a certain (typically short) period of time. Note that application authentication and authorization engine 104 will generate a different verification token for every app authentication process to ensure that every app accessing the web service is independently and individually authenticated and authorized. In addition to the verification token, the payload of the push notification also includes the device token application authentication and authorization engine 104 received from app engine 102. Based on the device token included in the payload of the push notification, the third-party push notification service further forwards the push notification to the intended computing/mobile device and application running on the device (Step 5). Here, the push notification service guarantees that the verification token will be delivered to the intended device and application combination as designated by the device token.

In some embodiments, app engine 102 receives the verification token from the third-party push notification service. After the token is received, the app engine 102 may use the received verification token (referred to hereinafter as the first verification token) to construct a second verification token using specific steps, wherein such steps may include but are not limited to, simply copying the received first verification token (in which case the second verification token is the same as the first verification token), or employing advanced cryptography methods like digital signatures; or using any other established method to generate the second verification token (in which case the second verification token is different from the first verification token). Note that both the first and the second verification tokens are temporary in nature for one-time use only.

In some embodiments, app engine 102 prompts user for credentials (UC) to access the remote service provided by web service engine 106 (Step 6). Once the credentials are collected from the user, app engine 102 provides the user's credentials to application authentication and authorization engine 104 together with the second verification token derived from the original first verification token (Step 7). Note that sending the second verification token to application authentication and authorization engine 104 is a specific and additional step required before the app is allowed to access the intended web service provided by the remote server.

In some embodiments, application authentication and authorization engine 104 utilizes the second verification token in addition to the user provided credentials to authenticate and authorize the application/app for accessing the web service hosted by web service engine 106 (Step 8). Specifically, in addition to verifying the user's credentials, application authentication and authorization engine 104 validates the second verification token received from app engine 102 using specific steps corresponding to the steps taken by the app engine 102 to construct the second verification token. For non-limiting examples, application authentication and authorization engine 104 may simply compare the second verification token to the first (original) verification token it generated and provided to the third party push notification service (if the second verification token is generated by simply copying the first verification token to the second), or use more advanced cryptographic techniques (like digital signatures); or any other pre-defined method to verify the second verification token if it is generated from the first verification token via other means.

If the validation of the second verification token is successful, application authentication and authorization engine 104 authenticates the application/app running on the computing/mobile device as valid and authorizes the app to access the web service provided by the web service engine 106 and associated data.

In some embodiments, application authentication and authorization engine 104 returns an API as the access token to app engine 102 for the app to access the web service hosted by web service engine 106 once the user's credentials and the second verification token are both validated to be authentic. In some embodiments, application authentication and authorization engine 104 may convert the one-time-use only second verification token with limited lifespan into the multi-use and persistent API access token that can be used in subsequent calls from the application/app to access the web service.

In some embodiments, app engine 102 enables the app running on the computing/mobile device to access the web service hosted by the web service engine 106 using the API access token received. App engine 102 may enforce security policies for the application on subsequent calls to the web service to ensure the necessary level of security protection by requesting application re-authentication and re-authorization at any time. For the purpose of re-authentication and re-authorization of the application, the process described above can be repeated at any time.

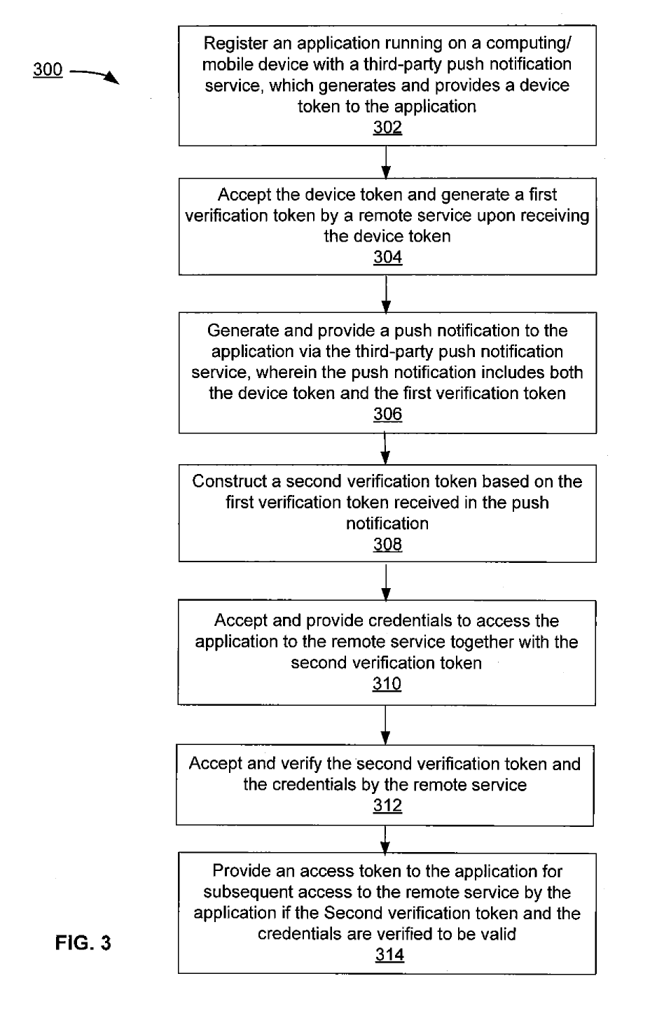

FIG. 3 depicts a flowchart of an example of a process to support push notification based application authentication and authorization. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302, where an application running on a computing/mobile device is registered with a third-party push notification service, which then generates and provides a device token to the application. The flowchart 300 continues to block 304, where a first verification token is generated by a remote service upon receiving the device token. The flowchart 300 continues to block 306, where a push notification is generated by the remove service and provided to the application via the third-party push notification service, wherein the push notification includes both the device token and the first verification token. The flowchart 300 continues to block 308, where a second verification token is generated/constructed based on the first verification token received in the push notification. The flowchart 300 continues to block 310, where credentials to access the application are accepted and provided to the remote service together with the second verification token. The flowchart 300 continues to block 312, where the second verification token and the login credentials are accepted and verified by the remote service. The flowchart 300 end at block 314 where an access token is provided to the application for subsequent access to the remote service by the application if the second verification token and the login credentials are verified to be valid.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a web service engine, which in operation, hosts and provides a web service on a remote server;
an app engine, which in operation,
enables an application running on a computing/mobile device to register with a third-party push notification service, wherein the third-party push notification service generates and provides a device token for the application;
receives a first verification token from a push notification and constructs a second verification token from the first verification token;
accepts and provides credentials to access the application together with the second verification token;
an application authentication and authorization engine, which in operation,
accepts the device token and generates said first verification token upon receiving the device token;
generates and provides said push notification to the application via the third-party push notification service, wherein the push notification includes the first verification token;
accepts and verifies the second verification token and the credentials;
provides an access token to the application for subsequent access to the remote service by the application if the second verification token and the credentials are verified to be valid.

2. The system of claim 1, wherein:
the app engine enables a user to access, launch, and interact with the application on the computing and/or mobile device.

3. The system of claim 2, wherein:
the app engine accepts input from the user in the form of plain text commands and/or hand/finger gestures on a touchscreen of the computing and/or mobile device.

4. The system of claim 2, wherein:
the app engine presents status and/or execution results of commands and/or instructions to the user.

5. The system of claim 1, wherein:
the push notification is delivered only to the application designated to access the web service.

6. The system of claim 1, wherein:
the push notification is always delivered to the computing and/or mobile device to which the device token is generated for.

7. The system of claim 1, wherein:
the push notification is encrypted when it is being transmitted over a network.

8. The system of claim 1, wherein:
the device token is associated with the computing and/or mobile device on which the application is running and is used by the push notification service to determine which computing/mobile device to send the push notification to.

9. The system of claim 1, wherein:
the app engine provides the device token received from the push notification service to the remote server.

10. The system of claim 9, wherein:
the app engine goes into a waiting state after sending the device token until the push notification is received.

11. The system of claim 1, wherein:
the second verification token is the same as the first verification token received from the push notification.

12. The system of claim 1, wherein:
the application authentication and authorization engine utilizes the second verification token in addition to the credentials to authenticate and authorize the application/app for accessing the web service.

13. The system of claim 1, wherein:
the application authentication and authorization engine authorizes the application to access the web service only after the application has been authenticated as valid.

14. The system of claim 1, wherein:
the first and the second verification tokens are for one-time-use only and have a time-limited lifespan.

15. The system of claim 14, wherein:
the application authentication and authorization engine converts the one-time-use only secondary verification into a multi-use and persistent access token for subsequent calls from the application/app to access the web service.

16. The system of claim 1, wherein:
the application authentication and authorization engine provides an API as the access token for the application to access the web service once the credentials and the second verification token are both verified to be authentic.

17. The system of claim 16, wherein:
the app engine enables the application to access the web service using the API access token.

18. A method, comprising:
registering an application running on a computing/mobile device with a third-party push notification service, which generates and provides a device token to the application;
accepting the device token and generating a first verification token by a remote service upon receiving the device token;
generating and providing a push notification to the application via the third-party push notification service, wherein the push notification includes the first verification token;
receiving the first verification token from the push notification and constructing a second verification token from the first verification token;
accepting and providing credentials to access the application to the remote service together with the second verification token;
accepting and verifying the second verification token and the credentials by the remote service;
providing an access token to the application for subsequent access to the remote service by the application if the second verification token and the credentials are verified to be valid.

19. The method of claim 18, further comprising:
enabling a user to access, launch, and interact with the application on the computing and/or mobile device.

20. The method of claim 19, further comprising:
accepting input from the user in the form of plain text commands and/or hand/finger gestures on a touchscreen of the computing and/or mobile device.

21. The method of claim 19, further comprising:
presenting status and/or execution results of commands and/or instructions to the user.

22. The method of claim 18, further comprising:
delivering the push notification only to the application designated to access the web service.

23. The method of claim 18, further comprising:
delivering the push notification to the computing and/or mobile device to which the device token is generated for.

24. The method of claim 18, further comprising:
encrypting the push notification when it is being transmitted over a network.

25. The method of claim 18, further comprising:
using the device token to determine which computing/mobile device to send the push notification to.

26. The method of claim 18, further comprising:
providing the device token received from the push notification service to the remote server.

27. The method of claim 26, further comprising:
going into a waiting state after sending the device token until the push notification is received.

28. The method of claim 18, further comprising:
utilizing the second verification token in addition to the credentials to authenticate and authorize the application/app for accessing the web service.

29. The method of claim 18, further comprising:
authorizing the application to access the web service only after the application has been authenticated as valid.

30. The method of claim 18, further comprising:
converting the one-time-use only second verification token into a multi-use and persistent access token for subsequent calls from the application/app to access the web service.

31. The method of claim 18, further comprising:
providing an API as the access token for the application to access the web service once the credentials and the second verification token are both verified to be authentic.

32. The method of claim 31, further comprising:
enabling the application to access the web service using the API access token.

33. A machine readable medium having software instructions stored thereon that when executed cause a system to:
register an application running on a computing/mobile device with a third-party push notification service, which generates and provides a device token to the application;
accept the device token and generate a first verification token by a remote service upon receiving the device token;
generate and provide a push notification to the application via the third-party push notification service, wherein the push notification includes the first verification token;
receive the first verification token from the push notification and construct a second verification token from the first verification token;
accept and provide credentials to access the application to the remote service together with the second verification token;
accept and second verify the verification token and the credentials by the remote service;
provide an access token to the application for subsequent access to the remote service by the application if the second verification token and the credentials are verified to be valid.
